(19) United States
(12) Patent Application Publication
(10) Pub. No.: US 2023/0420984 A1
(43) Pub. Date: Dec. 28, 2023

(54) RENEWABLE ENERGY CERTIFICATE VERIFICATION SYSTEM AND METHOD FOR VERIFYING RENEWABLE ENERGY CERTIFICATE

(71) Applicant: Hitachi, Ltd., Tokyo (JP)

(72) Inventors: Atsuya KUMAGAI, Tokyo (JP); Hiro TANAKA, Tokyo (JP); Yoji OZAWA, Tokyo (JP)

(73) Assignee: Hitachi, Ltd., Tokyo (JP)

(21) Appl. No.: 18/335,200

(22) Filed: Jun. 15, 2023

(30) Foreign Application Priority Data
Jun. 22, 2022 (JP) 2022-100734

(51) Int. Cl. H02J 13/00

(52) U.S. Cl. CPC H02J 13/00002

(57) ABSTRACT

A data center (DC) user device manages user power consumption in a time unit, and stores the user power consumption in a power consumption table. A DC provider device manages provider power consumption in a time unit and stores the provider power consumption in the power consumption table. A power retailer device measures provider power consumption for a certain period, and determines retailer power consumption when a measurement value of the provider power consumption is equal to a total value of all user power consumptions.

### BACKGROUND OF THE INVENTION

### 1. Field of the Invention

The present invention relates to a renewable energy certificate verification system and a method for verifying a renewable energy certificate.

2. Description of the Related Art

Examples of means for an electric power consumer to increase a utilization rate of renewable energy include purchase of a renewable energy certificate (REC) or a non-fossil fuel energy certificate. When a consumer purchases and amortizes a renewable energy certificate issued by a power generation company in association with power generation of renewable energy, electric energy consumed in a specific period can be regarded as derived from the renewable energy as described in the renewable energy certificate.

Although the renewable energy certificate conventionally certifies only a year of power generation as a period of power generation, there is a movement to reduce the period certified by the renewable energy certificate to one hour, for example, because actual power generation and power consumption fluctuate with time. Consumers accordingly purchase and amortize a renewable energy certificate in accordance with a time period actually consumed.

Various companies and the like have studied handling of such a renewable energy certificate in time units, and a uniform guideline is being set by the non-profit organization Energy Tag. The non-profit organization Energy Tag proposes to install not only conventional organizations such as power generators, power retailers, and consumers but also external organizations such as measurement organizations that measure power generation and consumption of renewable energy, issuance organizations that issue and transfer renewable energy certificates, and verification organizations that verify correspondence between power consumption and amortization by consumers.

When the renewable energy certificate is handled on a time basis, power consumers disclose a detailed amount of power consumption to an external organization such as a measurement organization, and thus causing a problem of concealing the detailed amount of power consumption.

Private Data Collection (PDC), https://hyperledger-fabric.readthedocs.io/ja/latest/private-data/private-data.html, which is Non-Patent literature 1, achieves concealment and tampering prevention of data by limiting participants who share data itself and sharing only a hash value of data with others. Application of Non-Patent literature 1 enables concealment and tampering prevention of power consumption data.

When amortization in secure environment of consumers is verified with Trusted Execution Environment (TEE), https://www.jstage.jst.go.jp/article/essfr/14/2/14_107/_pdf/-char/en, which is Non-Patent Literature 2, verification organizations can avoid holding power consumption data, and thus, the consumers can conceal the power consumption data.

### SUMMARY OF THE INVENTION

Unfortunately, when a data center (DC) consumes power, a DC provider that rents a device such as a server or an installation place thereof and a DC user who uses the device or the installation place are on different sides.

Then, the DC user is responsible for reducing CO2 emission, so that the DC user needs to purchase a renewable energy certificate. The DC user also needs to correctly amortize the purchased renewable energy certificate, so that reliability of power consumption for each DC user is required.

Combination of the PDC and the TEE is premised on reliability of the DC provider, and the reliability cannot be secured in a case where there is fraud or a problem.

It is an object of the present invention to provide a renewable energy certificate verification system of guaranteeing validity of power consumption data for each DC user while causing a DC provider and the DC user to conceal the power consumption data from an external organization.

A renewable energy certificate verification system according to an aspect of the present invention is configured to verify amortization of a renewable energy certificate, and includes a DC user device assigned to a DC user, a DC provider device assigned to a DC provider, and a power retailer device assigned to a power retailer. The DC user device includes a power consumption management unit that manages user power consumption in a time unit and a power consumption table to store the user power consumption in the power consumption table. The DC provider device includes a power consumption management unit that manages a provider power consumption in a time unit and the power consumption table to store the provider power consumption in the power consumption table. The power retailer device includes a power consumption determination unit and the power consumption table. The power consumption table is shared among the DC user device, the DC provider device, and the power retailer device. The power consumption determination unit of the power retailer device measures the provider power consumption in a certain period, and determines retailer power consumption when a measurement value of the provider power consumption is equal to a total value of all user power consumptions.

An aspect of the present invention enables a DC provider and a DC user to guarantee validity of power consumption data for each DC user while concealing the power consumption data from an external organization.

### BRIEF DESCRIPTION OF THE DRAWINGS

FIG. 1 is a system block diagram for practicing the present invention;

FIG. 2 is a block diagram of a power consumption measurement system;

FIG. 3 is an internal block diagram of a DC user calculator;

FIG. 4 is an internal block diagram of a DC provider calculator;

FIG. 5 is an internal block diagram of a power retailer calculator;

FIG. 6 is an internal block diagram of a measurement organization calculator;

FIG. 7 is an internal block diagram of an issuance verification organization calculator;

FIG. 8 is a block diagram of a power consumption table;

FIG. 9 is a block diagram of a shared hash value table;

FIG. 10 is a block diagram of a certificate management table;

FIG. 11 is a sequence diagram illustrating processing among a DC user, a DC provider, a power retailer, a measurement organization, and an issuance verification organization; and

FIG. 12 is a flowchart illustrating verification processing performed by a DC provider.

### DESCRIPTION OF THE PREFERRED EMBODIMENTS

Hereinafter, an embodiment will be described with reference to the drawings.

### Embodiment

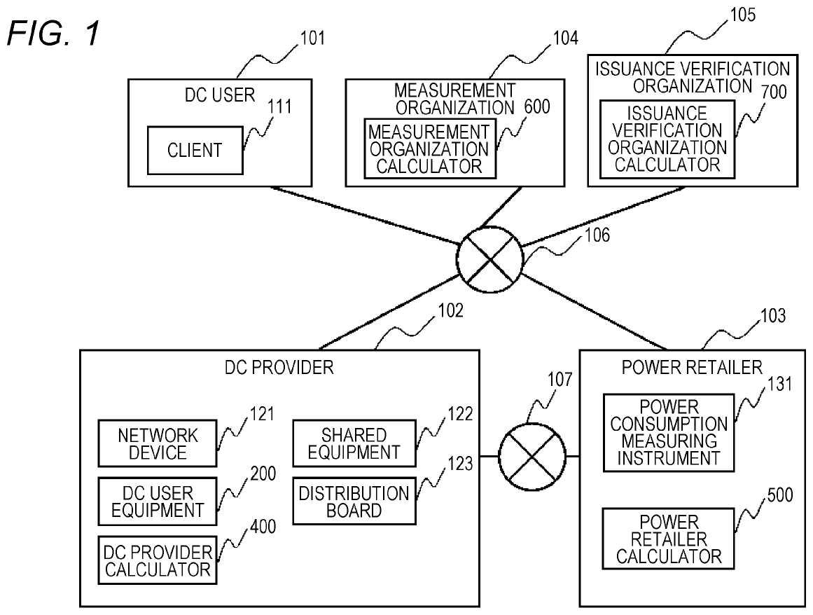

FIG. 1 is a system block diagram for practicing the present invention.

A DC user 101 uses DC user equipment 200 assigned to the DC user 101 in a DC provider 102 described later, and operates a client 111 to use the DC user equipment 200. The DC provider 102 operates and manages a data center including a network device 121, the DC user equipment 200, a DC provider calculator 400, shared equipment 122, and a distribution board 123, and provides the DC user 101 with use of a DC user calculator 300 based on a contract with the DC user 101.

The power retailer 103 provides electric power to the DC provider 102 and the like through an electric power network 107 described later, and includes a power consumption measuring instrument 131 and a power retailer calculator 500 described later.

A measurement organization 104 measures power consumption of purchasers including the DC provider 102 of renewable energy certificate in a time unit, and includes a measurement organization calculator 600 described later.

An issuance verification organization 105 issues a renewable energy certificate based on a measurement result of the power consumption obtained by the measurement organization 104, and includes an issuance verification organization calculator 700 described later. A network 106 is a communication network such as the Internet. The electric power network 107 is equipment for the power retailer 103 to supply electric power to the DC provider 102.

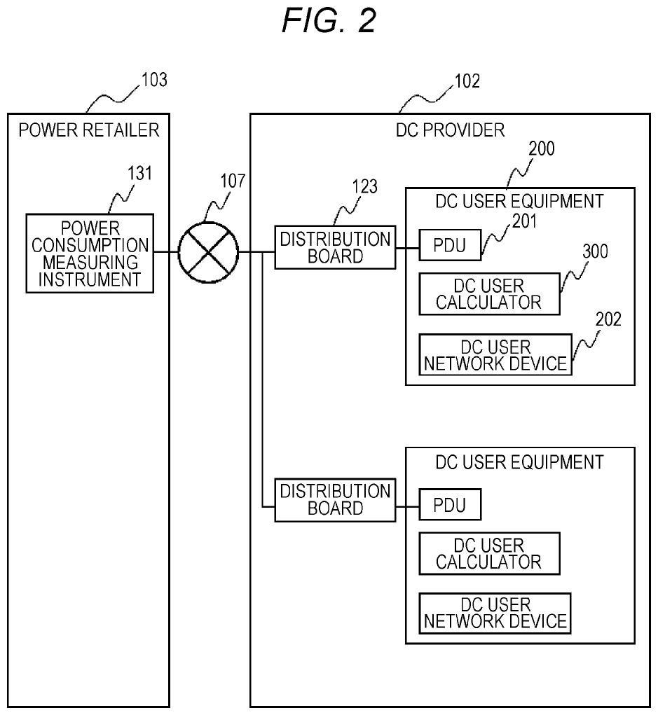

FIG. 2 is a block diagram of a power consumption measurement system.

The DC user equipment 200 is provided in a DC owned by the DC provider 102 while being set to be usable by the DC user 101 assigned, and includes a power distribution unit (PDU) 201, the DC user calculator 300 described later, and a DC user network device 203. The PDU 201 is connected to the distribution board 123 by a power cable to not only distribute power to devices in the DC user equipment 200, but also measure power consumption of the DC user equipment 200.

The distribution board 123 receives power supply from the power retailer 103 to relay the power to the DC user equipment. The power consumption measuring instrument 131 of the power retailer 103 measures electric energy consumed through each distribution board 123. The DC user network device 203 is connected to the DC user calculator 300 and the network device 121 by a LAN cable.

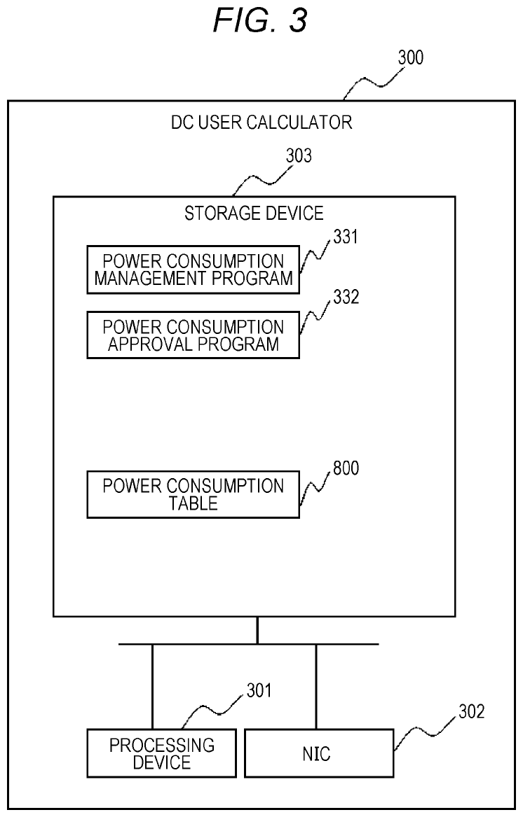

FIG. 3 illustrates the DC user calculator 300.

The DC user calculator 300 includes a processing device 301, an NIC 302, and a storage device 303. The processing device 301 is a device such as a CPU that reads and executes a program stored in the storage device 303. The NIC 302 is an interface for accessing the network 106 through connection to the network device 121.

The storage device 303 stores a power consumption management program 331, a power consumption approval program 332, and a power consumption table 800 described later.

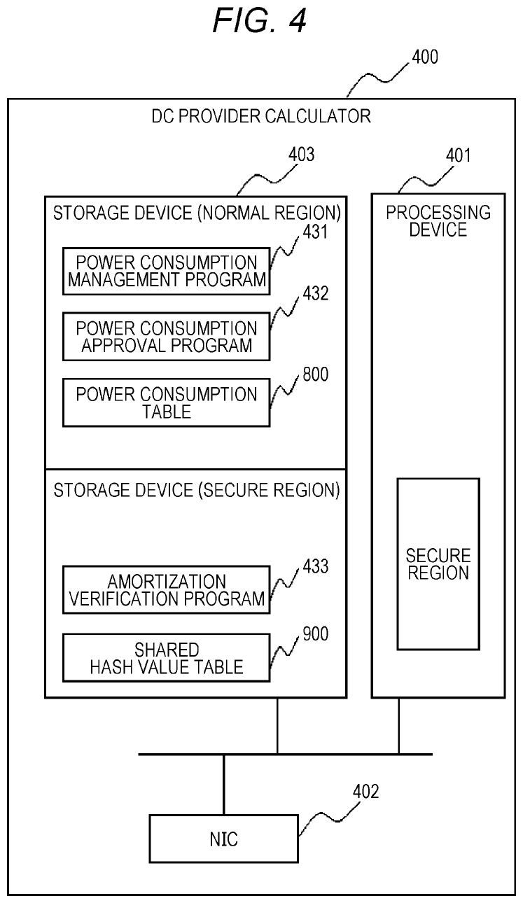

FIG. 4 illustrates the DC provider calculator 400.

The DC provider calculator 400 includes a processing device 401, an NIC 402, and a storage device 403. The processing device 401 is a device such as a CPU that reads and executes a program stored in the storage device 403.

The processing device 401 includes a secure region for exclusively accessing a secure region of the storage device 403 described later. The NIC 402 is an interface for accessing the network 106 through connection to the network device 121.

The storage device 403 includes a normal region in which a power consumption management program 431, a power consumption approval program 432, and the power consumption table 800 described later are stored. The storage device 403 include a secure region in which an amortization verification program 433 and a shared hash value table 900 described later are stored. The secure region of the storage device 403 can be accessed from other than the secure region in the processing device 401 only by a predetermined method via an application in the secure region of the storage device 403.

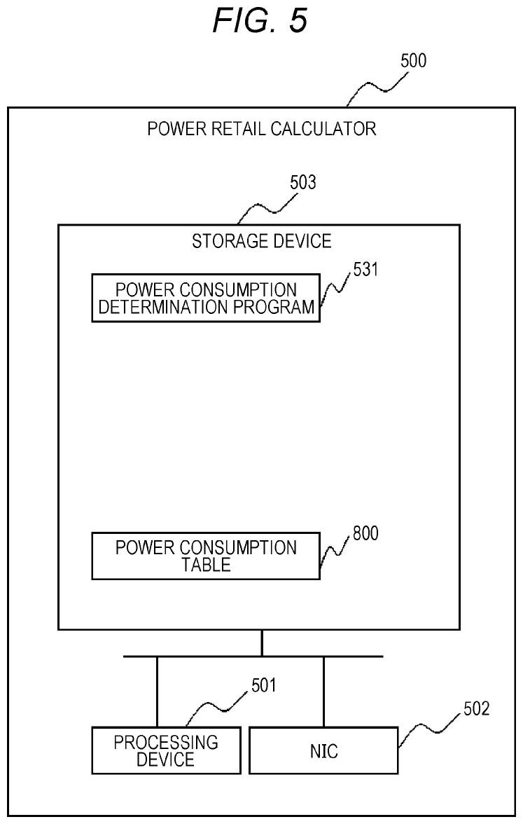

FIG. 5 illustrates the power retailer calculator 500.

The power retailer calculator 500 includes a processing device 501, an NIC 502, and a storage device 503. The processing device 501 is a device such as a CPU that reads and executes a program stored in the storage device 503. The NIC 502 is an interface for accessing the network 106.

The storage device 503 stores a power consumption determination program 531 and the power consumption table 800 described later.

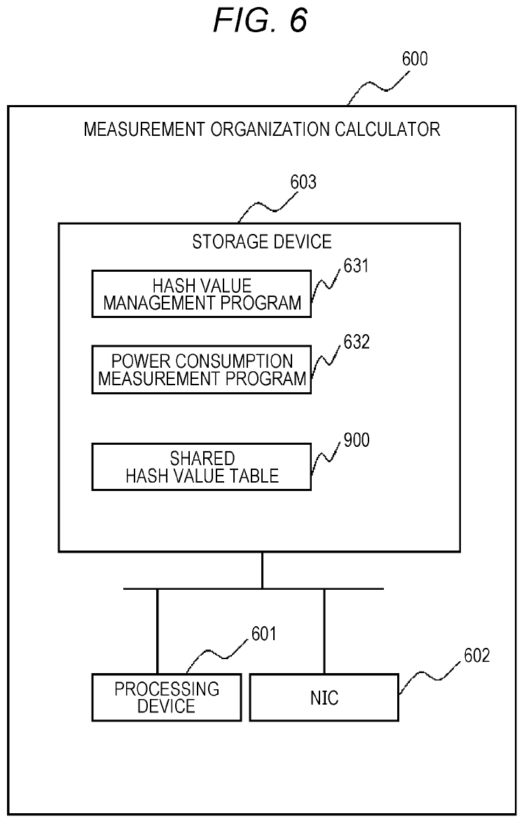

FIG. 6 illustrates the measurement organization calculator 600.

The measurement organization calculator 600 includes a processing device 601, an NIC 602, and a storage device 603. The processing device 601 is a device such as a CPU that reads and executes a program stored in the storage device 603. The NIC 602 is an interface for accessing the network 106.

The storage device 603 stores a hash value management program 631, a power consumption measurement program 632, and the power consumption tabulation table 900 described later.

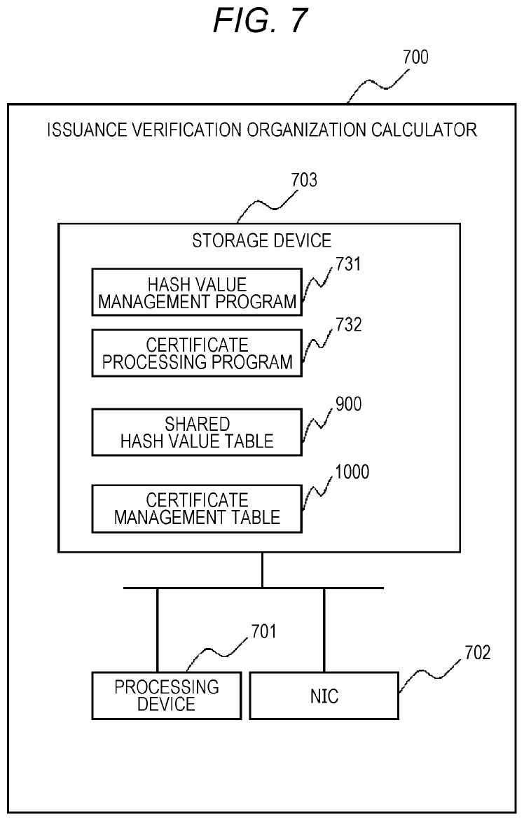

FIG. 7 illustrates the issuance verification organization calculator 700.

The issuance verification organization calculator 700 includes a processing device 701, an NIC 702, and a storage device 703. The processing device 701 is a device such as a CPU that reads and executes a program stored in the storage device 703. The NIC 702 is an interface for accessing the network 106.

The storage device 703 stores a hash value management program 731, a certificate processing program 732, the shared hash value table 900, and a certificate management table 1000 described later.

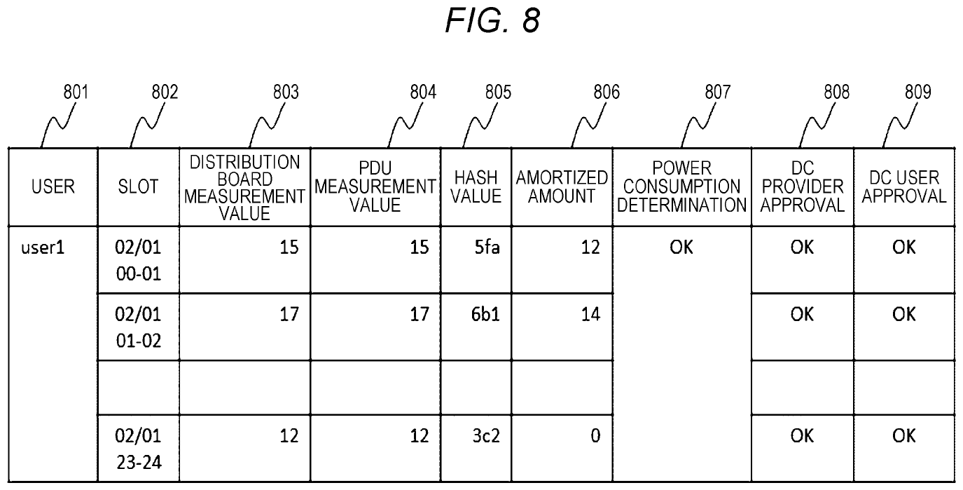

FIG. 8 illustrates the power consumption table 800 stored in the storage device 303 of the DC user calculator 300, the storage device 403 of the DC provider calculator 400, and the storage device 503 of the power retailer calculator 500.

The power consumption table 800 is held for each DC user 101, and includes a user 801, a slot 802, a distribution board measurement value 803, a PDU measurement value 804, a hash value 805, an amortized amount 806, a power consumption determination 807, a DC provider approval 808, and a DC user approval 809.

The user 801 stores the distribution board measurement value 803 and an identifier for identifying a user who has consumed power corresponding to the power consumption stored in the PDU measurement value 804. The slot 802 stores a time zone in which the power is consumed. The distribution board measurement value 803 stores power consumption measured by the DC provider 102 using the distribution board 123. The PDU measurement value 804 stores power consumption measured by the DC user 101 identified by the user 801 using the PDU 201.

The hash value 805 stores a hash value of the power consumption 804 described later. The amortized amount 806 stores electric energy amortized by the renewable energy certificate in the time zone identified by the slot 802. The power consumption determination 807 stores information on whether the power retailer 103 has approved the distribution board measurement value 803 and the PDU measurement value 804. The DC provider approval 808 stores information on whether the DC provider 102 has approved the PDU measurement value 804.

The DC user approval 809 stores information on whether the DC user 101 has approved the distribution board measurement value 803. The illustration in FIG. 8 means that the distribution board measurement value and the PDU measurement value in the time zone of 0:00 to 1:00 on February 1 of the user “user 1” are each 15 kWh, and 12 kWh is amortized from 15 kWh by the renewable energy certificate.

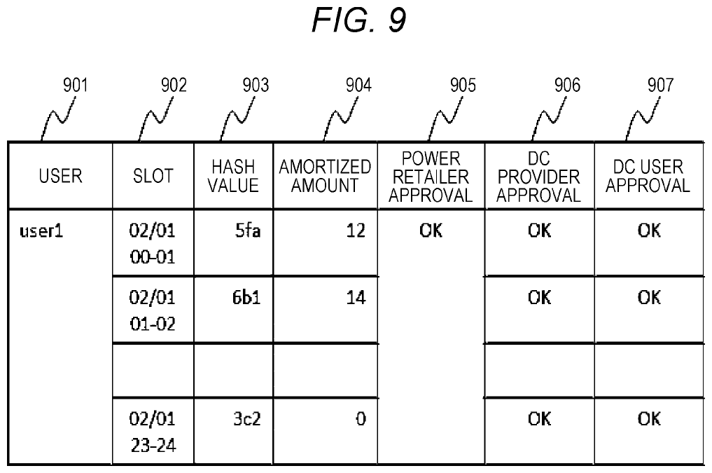

FIG. 9 illustrates the shared hash value table 900 shared among the DC provider 102, the power retailer 103, the measurement organization 104, and the issuance verification organization 105.

The shared hash value table 900 is similar to the power consumption table 800 except that the distribution board measurement value 803 and the PDU measurement value 804 in the power consumption table 800 are not present. The data stored in the shared hash value table 900 is synchronized with corresponding data in the power consumption table 800. That is, when the power consumption table 800 is updated, the corresponding data in the shared hash value table 900 is also updated, and when the shared hash value table 900 is updated, the corresponding data in the power consumption table 800 is also updated.

The shared hash value table 900 stores and shares only the hash value without storing the power consumption itself, so that the power consumption itself is concealed from the measurement organization 104 and the issuance verification organization 105 that are each a sharing destination.

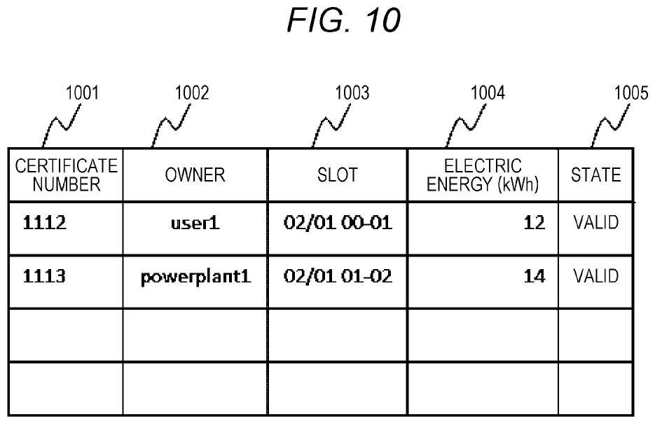

FIG. 10 illustrates the certificate management table 1000 stored in the storage device 703 of the issuance verification organization calculator 700 of the issuance verification organization 105.

The certificate management table 1000 includes a certificate number 1001, an owner 1002, a slot 1003, electric energy 1004, and a state 1005, and is used to manage the state and the like of the renewable energy certificate. The certificate number 1001 is an identifier for identifying the renewable energy certificate. The owner 1002 is an identifier for identifying an owner holding a certificate. The slot 1003 represents a time zone in which power is generated.

The electric energy 1004 represents electric energy certified by the renewable energy certificate. The state 1005 represents whether the renewable energy certificate is valid. For example, when the owner of the renewable energy certificate with the certificate number “1113 ” is “powerplant 1”, the slot is “02/0101-02”, the electric energy is “14”, and the state is “valid”, this certificate is owned by “powerplant 1”, and proves that 14 kWh of renewable energy is generated in the slot of 02/0100-01, and also means that the certificate is not amortized.

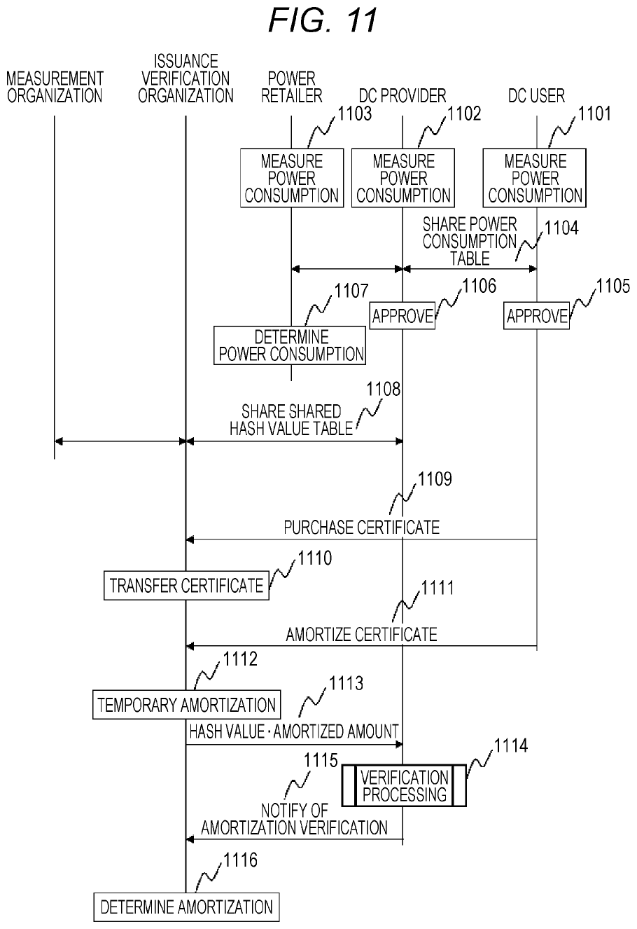

FIG. 11 is a sequence diagram illustrating processing performed among the DC user 101, the DC provider 102, the power retailer 103, the measurement organization 104, and the issuance verification organization 105.

The DC user 101 measures its own power consumption in a time unit with the PDU 201 assigned to the DC user 101 (1101), and writes the power consumption in the PDU measurement value 804 of the power consumption table 800 (1104).

The DC provider 102 measures power consumption of the DC user 101 using the distribution board 123 (1102), and writes the measured power consumption in the distribution board measurement value 803 of the power consumption table 800 (1104).

When the distribution board measurement value 803 is equal to the PDU measurement value 804 with reference to the power consumption table 800, the DC user 101 writes “OK” to the corresponding DC user approval 809 (1106). Similarly, when the distribution board measurement value 803 is equal to the PDU measurement value 804 with reference to the power consumption table 800, the DC provider 102 writes “OK” in the corresponding DC provider approval 808.

As described above, both the DC user 101 and the DC provider 102 approve the power consumption, so that the validity can be guaranteed without disclosing data on the power consumption to an external organization.

The power retailer 103 measures power consumption of the DC provider 102 in a certain period with the power consumption measuring instrument 131 (1103), and writes “OK” in the power consumption determination 807 of the corresponding slot when not only the measured value is equal to the sum of the distribution board measurement values 803 of all the DC users 101, but also the DC provider approval 808 is “OK” and the DC user approval 809 is “OK” (1107).

The DC provider 102 shares the shared hash value table 900 with the measurement organization 104 and the issuance verification organization 105 (1108).

The DC user 101 places an order for purchasing a renewable energy certificate in a specific slot with the issuance verification organization 105 to verify that the DC user 101 has used renewable energy. Upon receiving the order and completing payment, the issuance verification organization 105 updates the certificate management table 1000 to transfer the renewable energy certificate (1110). For example, when the DC user 101 identified by “user 1” purchases a renewable energy certificate with the certificate number “1113” while the renewable energy certificate is owned by the “powerplant 1”, the issuance verification organization 105 changes the owner 1002 to the “user 1”.

The DC user 101 places an order for amortizing the renewable energy certificate with the issuance verification organization 105 to determine the use of renewable energy in the corresponding time zone based on the purchased renewable energy certificate (1111).

Upon receiving the order, the issuance verification organization 105 updates the state 1005 of the corresponding renewable energy certificate in the certificate management table 1000 to “temporary amortization” (1112).

The issuance verification organization 105 notifies the DC provider 102 of a hash value and amortized electric energy that are in the shared hash value table 900 and that are specified from the owner of the renewable energy certificate that is temporarily amortized and the slot (1113).

Upon receiving the hash value and the amortized electric energy, the DC provider performs verification processing described later using the amortization verification program 433 in the storage device 403 of the DC provider calculator 400 (1114), and notifies the issuance verification organization 105 of a result of the verification processing (1115).

When the notified result of the verification is “verification OK”, the issuance verification organization 105 updates the state 1005 in the certificate management table 1000 to “invalid”, and writes the verified amortized amount in the amortized amount 904 in the shared hash value table 900 to determine the amortization of the renewable energy certificate (1116).

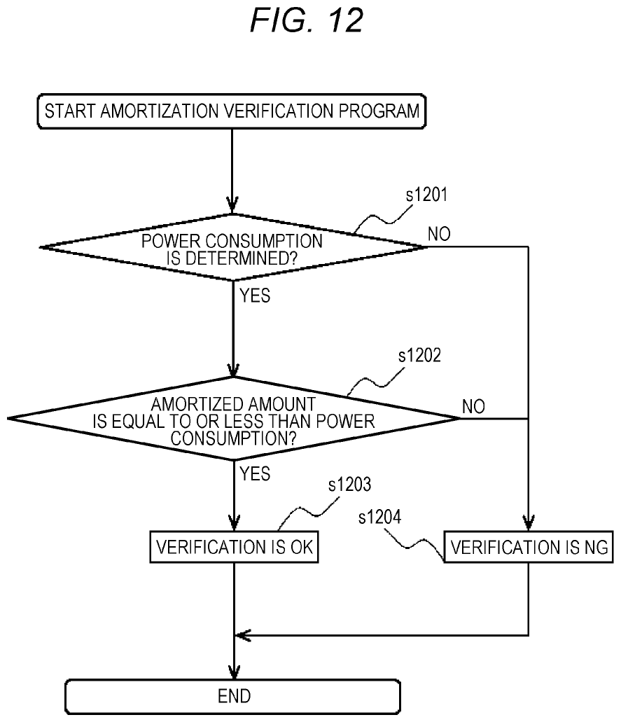

FIG. 12 is a flowchart illustrating the verification processing 1114 in the storage device 303 of the DC user calculator 300 of the DC provider.

The verification processing 1114 is performed as follows: when the power consumption determination 807 is “OK” (s1201: YES) with reference to the power consumption table 800, the power consumption table 800 is referred; and when the amortized amount in the notification 1113 from the issuance verification organization 105 is equal to or less than the distribution board measurement value 803 or less (s1202: YES), the issuance verification organization 105 is notified of “verification OK” as the result of the verification (s1203). When any one of determinations s1201 and s1202 shows “NO” as the result, the issuance verification organization 105 is notified of “verification NG” as a determination result (s1204).

The embodiment described above is a method for verifying amortization of a renewable energy certificate including the DC user (101), the DC provider (102), the power retailer (103), the measurement organization (104), and the issuance verification organization (105). The method is performed to verify the amortization of the renewable energy certificate and guarantee the validity of the amortization while concealing the power consumption (803, 804) in units of slots (802) from an external organization.

The DC user (101) and the DC provider (102) also mutually approve the power consumption (803, 804) in units of slots (802) based on a measurement value of each of the DC user (101) and the DC provider (102).

Then, the power retailer (103) determines the power consumption (803, 804) in units of slots (802) based on its own measurement value.

The DC provider (102) shares the hash value (805) of the power consumption (803, 804) in units of slots (802) with the measurement organization (104) and the issuance verification organization (105).

The amortization of the renewable energy certificate is verified in the secure region of the storage device 403 in the DC provider (102).

The above embodiment allows the validity of the amortization of the renewable energy certificate to be guaranteed while concealing power consumption data in a time unit for each DC user from an external organization.

The DC user and the DC provider mutually approve the power consumption in a time unit measured by each of the DC user and the DC provider, and the power retailer checks and determines the validity of the power consumption. The DC provider shares a hash value of the power consumption in a time unit with the measurement organization and the issuance verification organization. When the DC user amortizes the renewable energy certificate, the issuance verification organization verifies the validity of the amortization of the renewable energy certificate in the secure region of the storage device of the DC provider calculator by verifying the corresponding hash value and the power consumption to be amortized, and then determines the amortization.

The above embodiment allows a hash value of power consumption for each time zone (slot) and an approval status to be shared among the measurement organization, the issuance organization, the verification organization, the power retailer, the DC provider, and the DC user. The power consumption itself is shared only by the DC provider, the DC user, and the power retailer. Both the DC provider and the DC user approve the power consumption measured by each of the DC provider and the DC user, and the power retailer approves correctness of a total amount of power consumption in a certain period.

The above embodiment enables power consumption to be concealed from an external organization by causing the power consumption itself to shared only among the DC user 101, the DC provider 102, and the power retailer 103, while a hash value of the power consumption is shared among the DC user 101, the DC provider 102, the power retailer 103, the measurement organization 104, and the issuance verification organization 105. The power consumption is approved by the DC user 101 and the DC provider 102 and is then approved by the power retailer 103, and thus validity of the power consumption is guaranteed.

The above embodiment enables the DC provider and the DC user to guarantee validity of power consumption data for each DC user while concealing the power consumption data from an external organization.

When the amortization of the renewable energy certificate is determined, validity of the power consumption in a time unit of the DC user 101 and the amortized amount of the certificate is guaranteed. In general, the amount of CO2 emission associated with power consumption derived from non-renewable energy is obtained by multiplying the power consumption by an emission factor. Thus, the DC user 101 can accurately calculate the amount of CO2 emission in a time unit and the amount of CO2 reduction due to renewable energy of electric power.

The power consumption table 800 and the shared hash value table 900 described in the present embodiment can be shared by a blockchain.

What is claimed is:

1. A renewable energy certificate verification system configured to verify amortization of a renewable energy certificate, the renewable energy certificate verification system comprising:
a data center (DC) user device assigned to a DC user;
a DC provider device assigned to a DC provider; and
a power retailer device assigned to a power retailer,
the DC user device including:
a power consumption management unit that manages user power consumption in a time unit; and
a power consumption table,
the power consumption table being configured to store the user power consumption,
the DC provider device including:
a power consumption management unit that manages a provider power consumption in a time unit; and
the power consumption table,
the power consumption table being configured to store the provider power consumption,
the power retailer device including:
a power consumption determination unit; and
the power consumption table,
the power consumption table being shared among the DC user device, the DC provider device, and the power retailer device,
the power consumption determination unit of the power retailer device being configured to measure the provider power consumption in a certain period, and determine retailer power consumption when a measurement value of the provider power consumption is equal to a total value of all user power consumptions.

2. The renewable energy certificate verification system according to claim 1, wherein
the DC user device includes a power consumption approval unit that approves the user power consumption,
the DC provider device includes a power consumption approval unit that approves the provider power consumption, and
the power consumption determination unit of the power retail device determines the retailer power consumption when the power consumption approval unit of the DC user device approves the user power consumption and the power consumption approval unit of the DC provider device approves the provider power consumption.

3. The renewable energy certificate verification system according to claim 1, wherein
the power consumption management unit of the DC user device manages a power distribution unit (PDU) measurement value in a time unit measured by a PDU assigned to the DC user as the user power consumption, and stores the PDU measurement value as the user power consumption in the power consumption table,
the power consumption management unit of the DC provider device manages a distribution board measurement value in a time unit measured by a distribution board assigned to the DC provider as the provider power consumption, and stores the distribution board measurement value as the provider power consumption in the power consumption table, and
the power retail device measures the provider power consumption for a certain period of time with a power consumption measuring instrument.

4. The renewable energy certificate verification system according to claim 1, wherein
the DC provider device includes an amortization verification unit that performs verification processing of amortized electric energy, and
the amortization verification unit determines that a verification result is correct when the amortized electric energy is equal to or less than the provider power consumption.

5. The renewable energy certificate verification system according to claim 4, further comprising:
a measurement organization and an issuance verification organization, wherein
the DC provider device, the measurement organization, and the issuance verification organization each include a shared hash value table,
the shared hash value table is configured to store a hash value in a time unit of the provider power consumption, and share the shared hash value table among the DC provider device, the measurement organization, and the issuance verification organization to conceal the provider power consumption from the measurement organization and the issuance verification organization.

6. The renewable energy certificate verification system according to claim 5, wherein
the DC user device places an order for purchasing the renewable energy certificate in a predetermined time zone with the issuance verification organization,
the issuance verification organization transfers the renewable energy certificate when payment of the order received is completed,
the DC user device places an order for amortizing the renewable energy certificate with the issuance verification organization to determine use of renewable energy in the predetermined time zone based on the renewable energy certificate purchased,
the issuance verification organization notifies the DC provider device of the hash value and the amortized electric energy, and
the DC provider device receives the hash value and the amortized electric energy to allow the amortization verification unit to perform the verification processing, and notifies the issuance verification organization of a verification result.

7. The renewable energy certificate verification system according to claim 4, wherein
the DC provider device includes a storage device provided with a secure region, and
the amortization verification unit is stored in the secure region.

8. The renewable energy certificate verification system according to claim 5, wherein
the DC provider device includes a storage device provided with a secure region, and
the shared hash value table is stored in the secure region.

9. A method for verifying a renewable energy certificate to verify amortization of the renewable energy certificate using a renewable energy certificate verification system including a data center (DC) user device assigned to a DC user, a DC provider device assigned to a DC provider, and a power retailer device assigned to a power retailer, the method comprising:
managing user power consumption in a time unit in the DC user device;
storing the user power consumption in a power consumption table in the DC user device;
managing provider power consumption in a time unit in the DC provider device;
storing the provider power consumption in the power consumption table in the DC provider device;
measuring the provider power consumption in a certain period in the power retailer device; and
determining retailer power consumption when a measurement value of the provider power consumption is equal to a total value of all the user power consumptions in the power retailer device.

10. The method for verifying a renewable energy certificate according to claim 9, further comprising:
verifying amortization of the renewable energy certificate by securing validity of the amortization while concealing the user power consumption and the provider power consumption from an external organization.

11. The method for verifying a renewable energy certificate according to claim 9, further comprising:
approving the user power consumption in the DC user device;
approving the provider power consumption in the DC provider device; and
determining the retailer power consumption in the power retailer device when the DC user device approves the user power consumption and the DC provider device approves the provider power consumption.

12. The method for verifying a renewable energy certificate according to claim 9, further comprising:
performing verification processing of amortized electric energy in the DC provider device, and
determining that a verification result is correct when the amortized electric energy is equal to or less than the provider power consumption.

13. The method for verifying a renewable energy certificate according to claim 9, wherein
the renewable energy certificate verification system further includes a measurement organization and an issuance verification organization,
the DC provider device, the measurement organization, and the issuance verification organization each store a hash value in a time unit of the provider power consumption in a shared hash value table, and
the shared hash value table is shared among the DC provider device, the measurement organization, and the issuance verification organization to conceal the provider power consumption from the measurement organization and the issuance verification organization.

14. The method for verifying a renewable energy certificate according to claim 13, further comprising:
allowing the DC user device to place an order for purchasing the renewable energy certificate in a predetermined time zone with the issuance verification organization;
allowing the issuance verification organization to transfer the renewable energy certificate when payment of the order received is completed;
allowing the DC user device to place an order for amortizing the renewable energy certificate with the issuance verification organization to determine use of renewable energy in the predetermined time zone based on the renewable energy certificate purchased,
allowing the issuance verification organization to notify the DC provider device of the hash value and the amortized electric energy, and
allowing the DC provider device to receive the hash value and the amortized electric energy to perform the verification processing, and to notify the issuance verification organization of a verification result.

15. The method of verifying a renewable energy certificate according to claim 12, wherein
the verification processing of the amortized electric energy is performed in a secure region of a storage device of the DC provider device.
